(19) United States
(12) Patent Application Publication
(10) Pub. No.: US 2016/0050002 A1
(43) Pub. Date: Feb. 18, 2016

(54) FLEXIBLE ELEVATION BEAMFORMING

(71) Applicants: Chao WEI, San Diego, CA (US); Peng CHENG, San Diego, CA (US); Jilei HOU, San Diego, CA (US); QUALCOMM INCORPORATED, San Diego, CA (US)

(72) Inventors: Chao Wei, Beijing (CN); Peng CHENG, Beijing (CN); Jilei HOU, Beijing (CN)

(73) Assignee: QUALCOMM Incorporated, San Diego, CA (US)

(21) Appl. No.: 14/784,165

(22) PCT Filed: Oct. 14, 2013
(86) PCT No.: PCT/CN2013/085162

§ 371 Date: Oct. 13, 2015

(30) Foreign Application Priority Data
Apr. 15, 2013 (CN) PCT/CN2013/074206

(51) Int. Cl. H04B 7/06; H04B 7/04; H04W 72/04

(52) U.S. Cl. CPC H04B 7/0617; H04W 72/04; H04B 7/0478; H04W 88/02

(57) ABSTRACT

Flexible beamforming is disclosed in which a base station receives feedback from a user equipment (UE), in which the feedback is related to one or more reference signals transmitted by the base station. The base station will obtain a tilt adjustment based, at least in part, on the feedback and generate an elevation precoding vector based using the feed-back. Using the tilt adjustment and elevation precoding vector, the base station may then perform elevation beamforming with an antenna array of the base station for the UE.

### BACKGROUND

1. Field

Aspects of the present disclosure relate generally to wireless communication systems, and more particularly, to flexible elevation beamforming.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method of wireless communication includes receiving, at a base station, feedback from a UE, wherein the feedback is related to one or more reference signals, obtaining, at the base station, a tilt adjustment based, at least in part, on the feedback, generating an elevation precoding vector based, at least in part, on the feedback, and performing elevation beamforming with an antenna array of the base station for the UE using the tilt adjustment and elevation precoding vector.

In an additional aspect of the disclosure, a method of wireless communication includes applying, by a base station, a precoding matrix to a plurality of data stream layers for transmission to a UE on a first number, E, of logical antenna ports, wherein the plurality of data stream layers becomes a plurality of precoded symbols after the applying, mapping the plurality of precoded symbols for the E logical antenna ports onto a second number, M, of physical antenna elements, wherein the plurality of precoded symbols becomes a plurality of complex modulated symbols after the mapping, shifting a phase of the plurality of complex modulated symbols for each of the M physical antenna elements using a phase shift matrix associated with the UE, wherein the plurality of precoded symbols becomes a plurality of beamformed symbols after the shifting, and transmitting the plurality of beamformed symbols to the UE.

In an additional aspect of the disclosure, an apparatus configured for wireless communication includes means for receiving, at a base station, feedback from a UE, wherein the feedback is related to one or more reference signals, means for obtaining, at the base station, a tilt adjustment based, at least in part, on the feedback, means for generating an elevation precoding vector based, at least in part, on the feedback, and means for performing elevation beamforming with an antenna array of the base station for the UE using the tilt adjustment and elevation precoding vector.

In an additional aspect of the disclosure, an apparatus configured for wireless communication includes means for applying, by a base station, a precoding matrix to a plurality of data stream layers for transmission to a UE on a first number, E, of logical antenna ports, wherein the plurality of data stream layers becomes a plurality of precoded symbols after execution of the means for applying, mapping the plurality of precoded symbols for the E logical antenna ports onto a second number, M, of physical antenna elements, wherein the plurality of precoded symbols becomes a plurality of complex modulated symbols after execution of the means for mapping, means for shifting a phase of the plurality of complex modulated symbols for each of the M physical antenna elements using a phase shift matrix associated with the UE, wherein the plurality of precoded symbols becomes a plurality of beamformed symbols after execution of the means for shifting, and means for transmitting the plurality of beamformed symbols to the UE.

In an additional aspect of the disclosure, a computer program product has a non-transitory computer-readable medium having program code recorded thereon. This program code includes code for causing a computer to receive, at a base station, feedback from a UE, wherein the feedback is related to one or more reference signals, code for causing the computer to obtain, at the base station, a tilt adjustment based, at least in part, on the feedback, code for causing the computer to generate an elevation precoding vector based, at least in part, on the feedback, and code for causing the computer to perform elevation beamforming with an antenna array of the base station for the UE using the tilt adjustment and elevation precoding vector.

In an additional aspect of the disclosure, a computer program product has a non-transitory computer-readable medium having program code recorded thereon. This program code includes code for causing a computer to apply, by a base station, a precoding matrix to a plurality of data stream layers for transmission to a UE on a first number, E, of logical antenna ports, wherein the plurality of data stream layers becomes a plurality of precoded symbols after execution of the code for causing the computer to apply, code for causing the computer to map the plurality of precoded symbols for the E logical antenna ports onto a second number, M, of physical antenna elements, wherein the plurality of precoded symbols becomes a plurality of complex modulated symbols after execution of the code for causing the computer to map, code for causing the computer to shift a phase of the plurality of complex modulated symbols for each of the M physical antenna elements using a phase shift matrix associated with the UE, wherein the plurality of precoded symbols becomes a plurality of beamformed symbols after execution of the code for causing the computer to shift, and code for causing the computer to transmit the plurality of beamformed symbols to the UE.

In an additional aspect of the disclosure, an apparatus includes at least one processor and a memory coupled to the processor. The processor is configured to receive, at a base station, feedback from a UE, wherein the feedback is related to one or more reference signals, to obtain, at the base station, a tilt adjustment based, at least in part, on the feedback, to generate an elevation precoding vector based, at least in part, on the feedback, and to perform elevation beamforming with an antenna array of the base station for the UE using the tilt adjustment and elevation precoding vector.

In an additional aspect of the disclosure, an apparatus includes at least one processor and a memory coupled to the processor. The processor is configured to apply, by a base station, a precoding matrix to a plurality of data stream layers for transmission to a UE on a first number, E, of logical antenna ports, wherein the plurality of data stream layers becomes a plurality of precoded symbols after application of the precoding matrix, to map the plurality of precoded symbols for the E logical antenna ports onto a second number, M, of physical antenna elements, wherein the plurality of precoded symbols becomes a plurality of complex modulated symbols after the mapping, to shift a phase of the plurality of complex modulated symbols for each of the M physical antenna elements using a phase shift matrix associated with the UE, wherein the plurality of precoded symbols becomes a plurality of beamformed symbols after the shift, and to transmit the plurality of beamformed symbols to the UE.

### BRIEF DESCRIPTION OF THE DRAWINGS

FIG. 1 is a block diagram conceptually illustrating an example of a mobile communication system.

FIG. 2 is a block diagram conceptually illustrating a design of a base station/eNB and a UE configured according to one aspect of the present disclosure.

FIG. 3 is a block diagram illustrating a vertical antenna element.

FIG. 4 is a graph illustrating the antenna pattern of an antenna having a tilt of 5 degrees and a 3 dB half power beamwidth of 20 degrees.

FIGS. 5A-5D are graphs illustrating the antenna patterns using an example DFT codebook for elevation beamforming.

FIG. 6 is a block diagram illustrating a logical antenna.

FIG. 7 is a graph representing the antenna pattern for a logical antenna having two virtual elevation ports, fl and f2, and ten physical elements, with a tilt of 5 degrees.

FIGS. 8A-8B are graphs illustrating the antenna patterns using an example DFT codebook for elevation beamforming using the beamspace logical antenna concept.

FIG. 9 is a block diagram illustrating an eNB configured for flexible elevation beamforming according to one aspect of the present disclosure.

FIG. 10 is a functional block diagram illustrating example blocks executed to implement one aspect of the present disclosure.

FIG. 11 is a functional block diagram illustrating example blocks executed to implement one aspect of the present disclosure.

FIG. 12 is a graph illustrating antenna patterns attributable to different orthogonal reference signals in a shift matrix estimation procedure configured according to one aspect of the present disclosure.

FIG. 13 is a block diagram illustrating a 2D Uniform Planar Array (UPA) antenna array configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

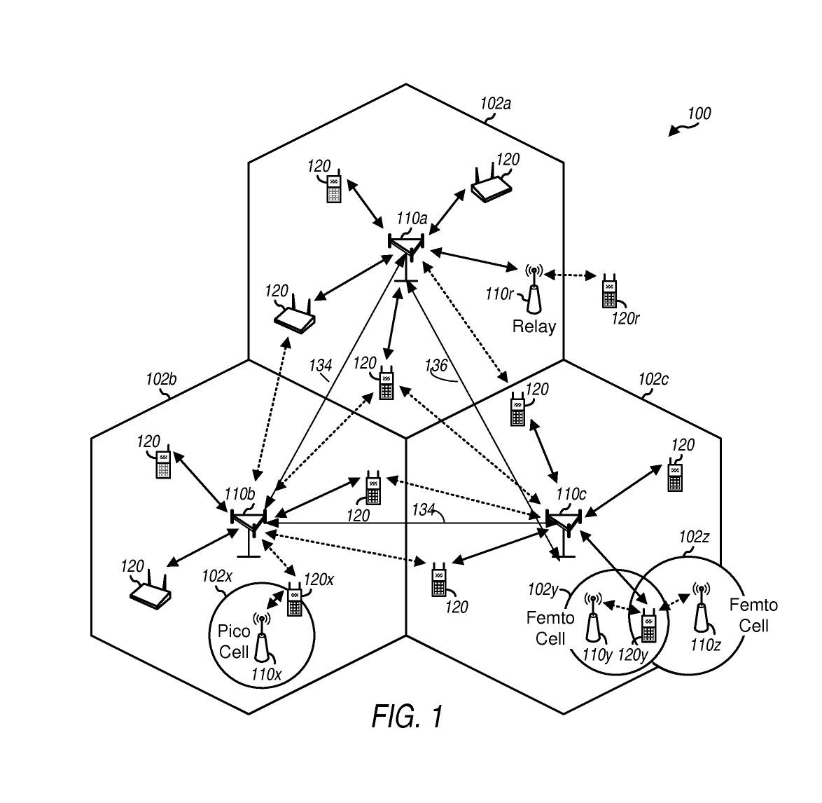

FIG. 1 shows a wireless network 100 for communication, which may be an LTE-A network. The wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the eNBs 110a, 110b and 110c are macro eNBs for the macro cells 102a, 102b and 102c, respectively. The eNB 110x is a pico eNB for a pico cell 102x. And, the eNBs 110y and 110z are femto eNBs for the femto cells 102y and 102z, respectively. An eNB may support one or multiple (e.g., two, three, four, and the like) cells.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

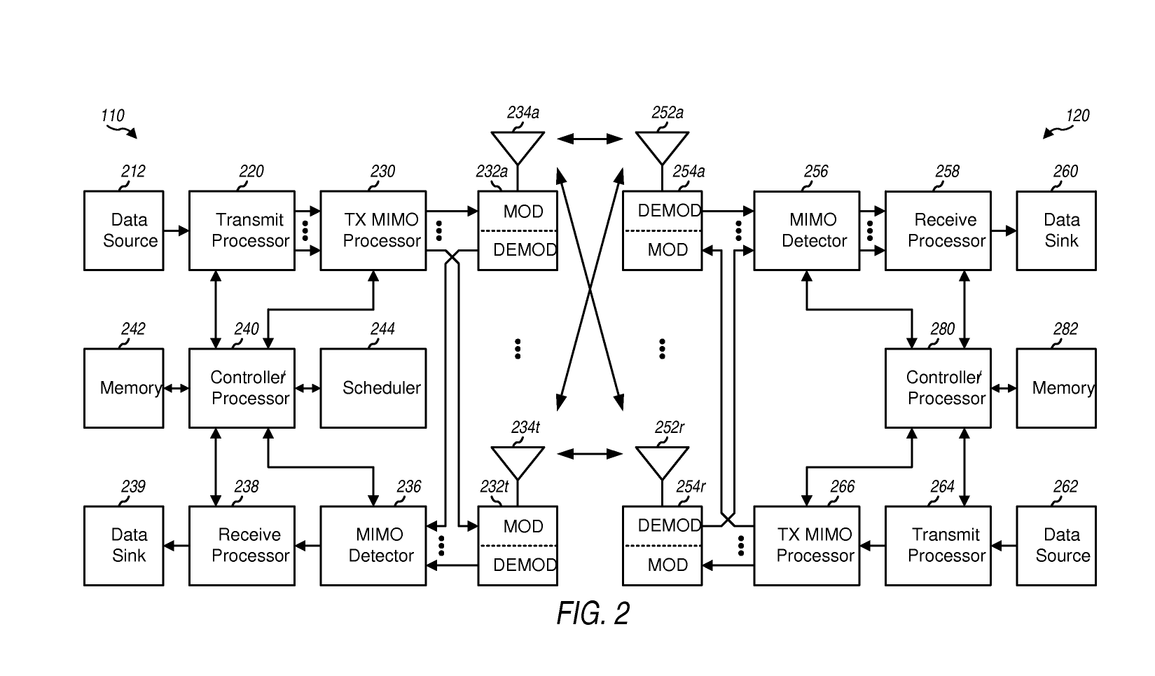

In LTE/-A, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

In addition to sending PHICH and PDCCH in the control section of each subframe, i.e., the first symbol period of each subframe, the LTE-A may also transmit these control-oriented channels in the data portions of each subframe as well. As shown in FIG. 2, these new control designs utilizing the data region, e.g., the Relay-Physical Downlink Control Channel (R-PDCCH) and Relay-Physical HARQ Indicator Channel (R-PHICH) are included in the later symbol periods of each subframe. The R-PDCCH is a new type of control channel utilizing the data region originally developed in the context of half-duplex relay operation. Different from legacy PDCCH and PHICH, which occupy the first several control symbols in one subframe, R-PDCCH and R-PHICH are mapped to resource elements (REs) originally designated as the data region. The new control channel may be in the form of Frequency Division Multiplexing (FDM), Time Division Multiplexing (TDM), or a combination of FDM and TDM.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

The wireless network 100 uses the diverse set of eNBs 110 (i.e., macro eNBs, pico eNBs, femto eNBs, and relays) to improve the spectral efficiency of the system per unit area. Because the wireless network 100 uses such different eNBs for its spectral coverage, it may also be referred to as a heterogeneous network. The macro eNBs 110a-c are usually carefully planned and placed by the provider of the wireless network 100. The macro eNBs 110a-c generally transmit at high power levels (e.g., 5 W-40 W). The pico eNB 110x, which generally transmits at substantially lower power levels (e.g., 100 mW-2 W), may be deployed in a relatively unplanned manner to eliminate coverage holes in the coverage area provided by the macro eNBs 110a-c and improve capacity in the hot spots. The femto eNBs 110y-z, which are typically deployed independently from the wireless network 100 may, nonetheless, be incorporated into the coverage area of the wireless network 100 either as a potential access point to the wireless network 100, if authorized by their administrator(s), or at least as an active and aware eNB that may communicate with the other eNBs 110 of the wireless network 100 to perform resource coordination and coordination of interference management. The femto eNBs 110y-z typically also transmit at substantially lower power levels (e.g., 100 mW-2 W) than the macro eNBs 110a-c.

In operation of a heterogeneous network, such as the wireless network 100, each UE is usually served by the eNB 110 with the better signal quality, while the unwanted signals received from the other eNBs 110 are treated as interference. While such operational principals can lead to significantly sub-optimal performance, gains in network performance are realized in the wireless network 100 by using intelligent resource coordination among the eNBs 110, better server selection strategies, and more advanced techniques for efficient interference management.

A pico eNB, such as the pico eNB 110x, is characterized by a substantially lower transmit power when compared with a macro eNB, such as the macro eNBs 110a-c. A pico eNB will also usually be placed around a network, such as the wireless network 100, in an ad hoc manner. Because of this unplanned deployment, wireless networks with pico eNB placements, such as the wireless network 100, can be expected to have large areas with low signal to interference conditions, which can make for a more challenging RF environment for control channel transmissions to UEs on the edge of a coverage area or cell (a “cell-edge” UE). Moreover, the potentially large disparity (e.g., approximately 20 dB) between the transmit power levels of the macro eNBs 110a-c and the pico eNB 110x implies that, in a mixed deployment, the downlink coverage area of the pico eNB 110x will be much smaller than that of the macro eNBs 110a-c.

In the uplink case, however, the signal strength of the uplink signal is governed by the UE, and, thus, will be similar when received by any type of the eNBs 110. With the uplink coverage areas for the eNBs 110 being roughly the same or similar, uplink handoff boundaries will be determined based on channel gains. This can lead to a mismatch between downlink handover boundaries and uplink handover boundaries. Without additional network accommodations, the mismatch would make the server selection or the association of UE to eNB more difficult in the wireless network 100 than in a macro eNB-only homogeneous network, where the downlink and uplink handover boundaries are more closely matched.

If server selection is based predominantly on downlink received signal strength, the usefulness of mixed eNB deployment of heterogeneous networks, such as the wireless network 100, will be greatly diminished. This is because the larger coverage area of the higher powered macro eNBs, such as the macro eNBs 110a-c, limits the benefits of splitting the cell coverage with the pico eNBs, such as the pico eNB 110x, because, the higher downlink received signal strength of the macro eNBs 110a-c will attract all of the available UEs, while the pico eNB 110x may not be serving any UE because of its much weaker downlink transmission power. Moreover, the macro eNBs 110a-c will likely not have sufficient resources to efficiently serve those UEs. Therefore, the wireless network 100 will attempt to actively balance the load between the macro eNBs 110a-c and the pico eNB 110x by expanding the coverage area of the pico eNB 110x. This concept is referred to as cell range extension (CRE).

The wireless network 100 achieves CRE by changing the manner in which server selection is determined. Instead of basing server selection on downlink received signal strength, selection is based more on the quality of the downlink signal. In one such quality-based determination, server selection may be based on determining the eNB that offers the minimum path loss to the UE. Additionally, the wireless network 100 provides a fixed partitioning of resources between the macro eNBs 110a-c and the pico eNB 110x. However, even with this active balancing of load, downlink interference from the macro eNBs 110a-c should be mitigated for the UEs served by the pico eNBs, such as the pico eNB 110x. This can be accomplished by various methods, including interference cancellation at the UE, resource coordination among the eNBs 110, or the like.

In a heterogeneous network with cell range extension, such as the wireless network 100, in order for UEs to obtain service from the lower-powered eNBs, such as the pico eNB 110x, in the presence of the stronger downlink signals transmitted from the higher-powered eNBs, such as the macro eNBs 110a-c, the pico eNB 110x engages in control channel and data channel interference coordination with the dominant interfering ones of the macro eNBs 110a-c. Many different techniques for interference coordination may be employed to manage interference. For example, inter-cell interference coordination (ICIC) may be used to reduce interference from cells in co-channel deployment. One ICIC mechanism is adaptive resource partitioning. Adaptive resource partitioning assigns subframes to certain eNBs. In subframes assigned to a first eNB, neighbor eNBs do not transmit. Thus, interference experienced by a UE served by the first eNB is reduced. Subframe assignment may be performed on both the uplink and downlink channels.

For example, subframes may be allocated between three classes of subframes:

protected subframes (U subframes), prohibited subframes (N subframes), and common subframes (C subframes). Protected subframes are assigned to a first eNB for use exclusively by the first eNB. Protected subframes may also be referred to as “clean” subframes based on the lack of interference from neighboring eNBs. Prohibited subframes are subframes assigned to a neighbor eNB, and the first eNB is prohibited from transmitting data during the prohibited subframes. For example, a prohibited subframe of the first eNB may correspond to a protected subframe of a second interfering eNB. Thus, the first eNB is the only eNB transmitting data during the first eNB's protected subframe. Common subframes may be used for data transmission by multiple eNBs. Common subframes may also be referred to as “unclean” subframes because of the possibility of interference from other eNBs.

At least one protected subframe is statically assigned per period. In some cases only one protected subframe is statically assigned. For example, if a period is 8 milliseconds, one protected subframe may be statically assigned to an eNB during every 8 milliseconds. Other subframes may be dynamically allocated.

Adaptive resource partitioning information (ARPI) allows the non-statically assigned subframes to be dynamically allocated. Any of protected, prohibited, or common subframes may be dynamically allocated (AU, AN, AC subframes, respectively). The dynamic assignments may change quickly, such as, for example, every one hundred milliseconds or less.

Heterogeneous networks may have eNBs of different power classes. For example, three power classes may be defined, in decreasing power class, as macro eNBs, pico eNBs, and femto eNBs. When macro eNBs, pico eNBs, and femto eNBs are in a co-channel deployment, the power spectral density (PSD) of the macro eNB (aggressor eNB) may be larger than the PSD of the pico eNB and the femto eNB (victim eNBs) creating large amounts of interference with the pico eNB and the femto eNB. Protected subframes may be used to reduce or minimize interference with the pico eNBs and femto eNBs. That is, a protected subframe may be scheduled for the victim eNB to correspond with a prohibited subframe on the aggressor eNB.

In deployments of heterogeneous networks, such as the wireless network 100, a

UE may operate in a dominant interference scenario in which the UE may observe high interference from one or more interfering eNBs. A dominant interference scenario may occur due to restricted association. For example, in FIG. 1, the UE 120y may be close to the femto eNB 110y and may have high received power for the eNB 110y. However, the UE 120y may not be able to access the femto eNB 110y due to restricted association and may then connect to the macro eNB 110c or to the femto eNB 110z also with lower received power (not shown in FIG. 1). The UE 120y may then observe high interference from the femto eNB 110y on the downlink and may also cause high interference to the eNB 110y on the uplink. Using coordinated interference management, the eNB 110c and the femto eNB 110y may communicate over the backhaul 134 to negotiate resources. In the negotiation, the femto eNB 110y agrees to cease transmission on one of its channel resources, such that the UE 120y will not experience as much interference from the femto eNB 110y as it communicates with the eNB 110c over that same channel.

In addition to the discrepancies in signal power observed at the UEs in such a dominant interference scenario, timing delays of downlink signals may also be observed by the UEs, even in synchronous systems, because of the differing distances between the UEs and the multiple eNBs. The eNBs in a synchronous system are presumptively synchronized across the system. However, for example, considering a UE that is a distance of 5 km from the macro eNB, the propagation delay of any downlink signals received from that macro eNB would be delayed approximately 16.67 μs (5 km±3×10⁸, i.e., the speed of light, ‘c’). Comparing that downlink signal from the macro eNB to the downlink signal from a much closer femto eNB, the timing difference could approach the level of a time-to-live (TTL) error.

Additionally, such timing difference may impact the interference cancellation at the UE. Interference cancellation often uses cross correlation properties between a combination of multiple versions of the same signal. By combining multiple copies of the same signal, interference may be more easily identified because, while there will likely be interference on each copy of the signal, it will likely not be in the same location. Using the cross correlation of the combined signals, the actual signal portion may be determined and distinguished from the interference, thus, allowing the interference to be canceled.

FIG. 2 shows a block diagram of a design of a base station/eNB 110 and a UE 120, which may be one of the base stations/eNBs and one of the UEs in FIG. 1. For a restricted association scenario, the eNB 110 may be the macro eNB 110c in FIG. 1, and the UE 120 may be the UE 120y. The eNB 110 may also be a base station of some other type. The eNB 110 may be equipped with antennas 234a through 234t, and the UE 120 may be equipped with antennas 252a through 252r.

At the eNB 110, a transmit processor 220 may receive data from a data source 212 and control information from a controller/processor 240. The control information may be for the PBCH, PCFICH, PHICH, PDCCH, etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the eNB 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the demodulators 254a through 254r (e.g., for SC-FDM, etc.), and transmitted to the eNB 110. At the eNB 110, the uplink signals from the UE 120 may be received by the antennas 234, processed by the modulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

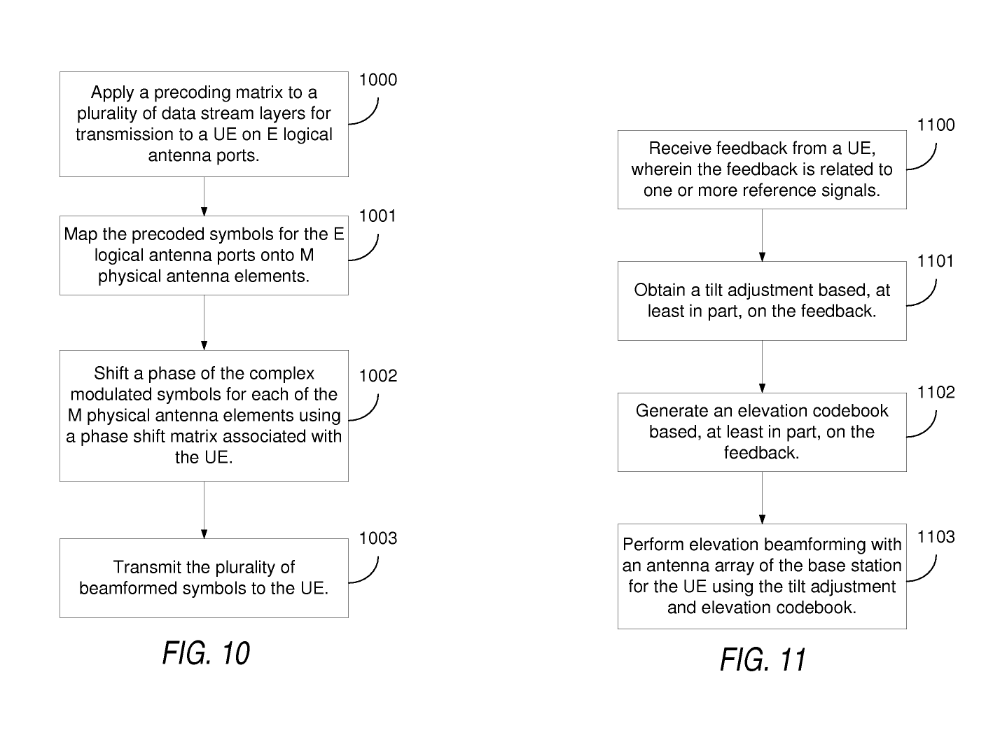

The controllers/processors 240 and 280 may direct the operation at the eNB 110 and the UE 120, respectively. The controller/processor 240 and/or other processors and modules at the eNB 110 may perform or direct the execution of various processes for the techniques described herein. The controllers/processor 280 and/or other processors and modules at the UE 120 may also perform or direct the execution of the functional blocks illustrated in FIGS. 10 and 11, and/or other processes for the techniques described herein. The memories 242 and 282 may store data and program codes for the eNB 110 and the UE 120, respectively. A scheduler 244 may schedule UEs for data transmission on the downlink and/or uplink.

Elevation beamforming is seen as one of the effective methods to improve system capacity and increase received signal-to-noise ratio (SNR) at the UE. It is being studied in 3GPP as a downlink MIMO enhancement technique for LTE. One of the key enabling techniques for elevation beamforming is to use a precoding matrix indicator (PMI) feedback-based precoding. However, a PMI feedback based precoding method may not be best suitable for an array of vertically deployed antenna elements due to the relatively smaller number of visible antenna ports than physical elements. Another reason may be that antenna pattern beamwidth in elevation is more narrow as compared to the beamwidth in azimuth of current antenna arrays.

There are several potential ways to perform elevation beamforming based on a trade-off between complexity and performance. In a first implementation, the number of elevation antenna ports are much fewer than the number of physical antenna elements (E-ports and Q elements, where Q>>E, e.g., E=2 and Q=10). With such a relationship, a fixed mapping of logical antenna ports to physical elements may be implemented in RF, rather than at baseband, in which the number of RF transceivers is equal to the number of logical ports. However, this method has only limited beamforming gain, because a base station can generally only control the phase between logical antenna ports based on UE feedback, e.g. using PMI feedback for precoding.

In a second implementation, elevation beamforming is conducted with Q-ports and Q physical elements, that is, there are the same number of logical ports as physical elements and both numbers are very large, Q=8, 16, 32, etc.). This solution could achieve the maximum elevation beamforming gain in an ideal case. A full digital implementation using UE-specific feedback for the antenna mapping matrix, F, and the phase shift matrix, Dₙ, operates such that F and Dₙ are combined with the channel PMI feedback, Wₙ. Such an implementation for large antenna ports elevation beamforming results in a very high overhead and complexity for CSI-RS channel measurements and PMI-based Wₙ. feedback due to the increase of antenna ports. Considering the limitations of pilot overhead for UE measurements and also the feedback overhead and complexity, the actual beamforming gain may be quite limited in a real deployment.

Various aspects of the present disclosure disclose a flexible elevation beamforming with joint consideration of both UE-specific tilt control and PMI feedback based phase control of the elevation antenna ports. The tilt control is used to find the coarse direction of the UE in elevation, based on a wideband and long term channel property, while the PMI-based precoding is further utilized to adjust the phase between elevation ports based on the short-term channel information. To support this flexible elevation beamforming, a feedback mechanism is also provided with separate feedback of tilt control command and PMI for elevation port phase control. With this proposal each UE in the network may be individually controlled in the elevation domain in order to maximize beamforming gain.

Aspects of the present disclosure provide a flexible elevation beamforming using a large number, M, of RF transceiver but fewer elevation antenna ports, E, that are visible to UEs. Thus, even though the UEs may be capable of feedback measurements for each of a larger number, M, of antenna ports, the feedback mechanism is restricted only to the ports that are visible to the UEs. The associated base stations use the feedback for the fewer, E, antenna ports to adjust each of the M RF transceivers/antenna elements. This proposed solution could maximize elevation beamforming gain, while at the same time reduce the downlink pilot and PMI-based feedback overhead to the same level as the fixed mapping implementation. Accordingly, the solutions configured according to various aspects of the present disclosure are conducted using E-ports and M RF chains (M>>E) which: (1) maximizes the elevation beamforming gain; and (2) reduces downlink CSI-RS and PMI-based feedback overhead.

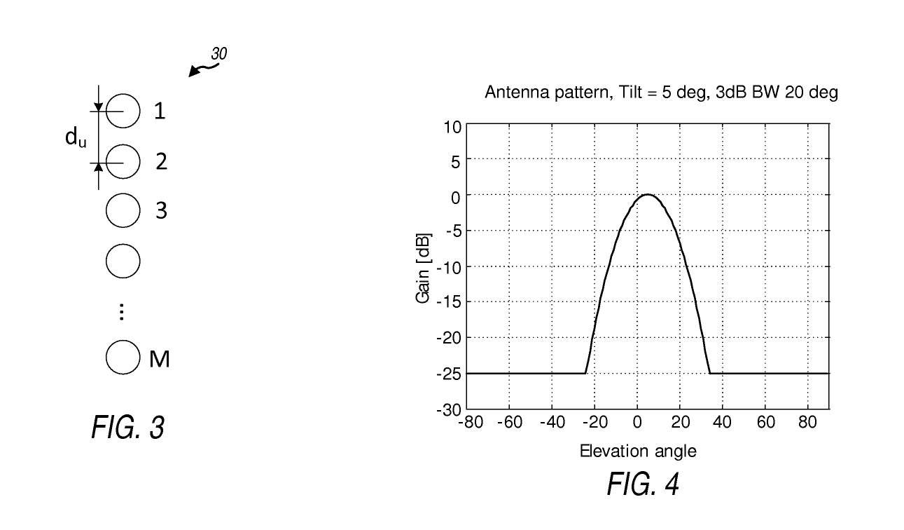

FIG. 3 is a block diagram illustrating a vertical antenna array 30. Vertical antenna array 30 is a typical vertical element array which includes M antenna physical elements. Each of the individual physical elements are spaced at a distance, dᵤ. The distance dᵤ may be a multiple of a wavelength, X, e.g., 0.5×, 2×, and the like.

In implementations of beamforming technologies, DFT vector-based codebook construction is widely used for correlated channels of uniform linear array (ULA), since the array antenna response vector can be well matched by DFT vectors.

$$Array response vector \text{:} a ( θ ) = {\frac{1}{\sqrt{{N}_{T}}} [ \begin{matrix}1 & {e}^{j2π \frac{d}{λ} sin θ} & … & {e}^{j2π \frac{d ( {N}_{T} - 1 )}{λ}} & sin θ\end{matrix} ]}^{T}$$

$$DFT vectors \text{:} {f}_{m} = {\frac{1}{\sqrt{{N}_{T}}} [ \begin{matrix}1 & {e}^{j2π \frac{k}{K}} & … & {e}^{j2π \frac{( {N}_{T} - 1 ) k}{K}}\end{matrix} ]}^{T}$$

In LTE Rel-10, the 8-transmitter codebook with double level structure is proposed where the base codebook is based on a 4-transmitter DFT vector describing wideband and/or long-term channel properties. The DFT vector-based codebook construction is based on uniform sampling of a spatial signal and an oversampling rate defined by K/N_{T}, where K represents the number of total beams by DFT vectors and N_{T} is the number of transmit antennas. DFT vector-based codebooks are well applied to arrays of horizontally deployed antennas but might not be suitable for arrays of vertically deployed antennas, since the beamwidth of an antenna pattern in the vertical direction is typically more narrow than that in the horizontal direction.

For example, a vertical antenna pattern may be defined based on the following equation:

Vertical pattern: A(θ)=−min(12×((θ−θₜᵢₗₜ)/θ_{3dB})²,25) (1)

where θ_{3dB} is half power beamwidth, and θₜᵢₗₜ, is the downtilt angle. FIG. 4 is a graph illustrating the vertical pattern of an antenna having a tilt of 5 degrees and a 3dB half power beamwidth of 20 degrees. Accordingly, the highest gain is shown at 5 degrees elevation angle above 0 degrees elevation.

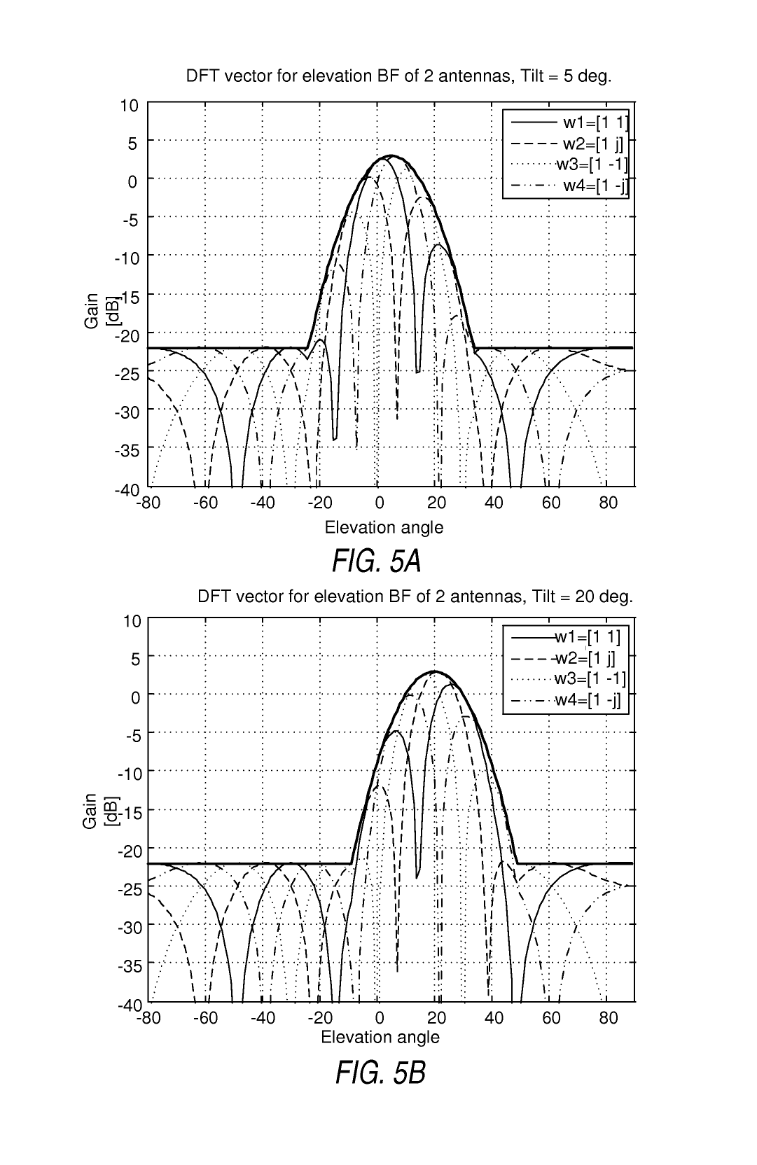

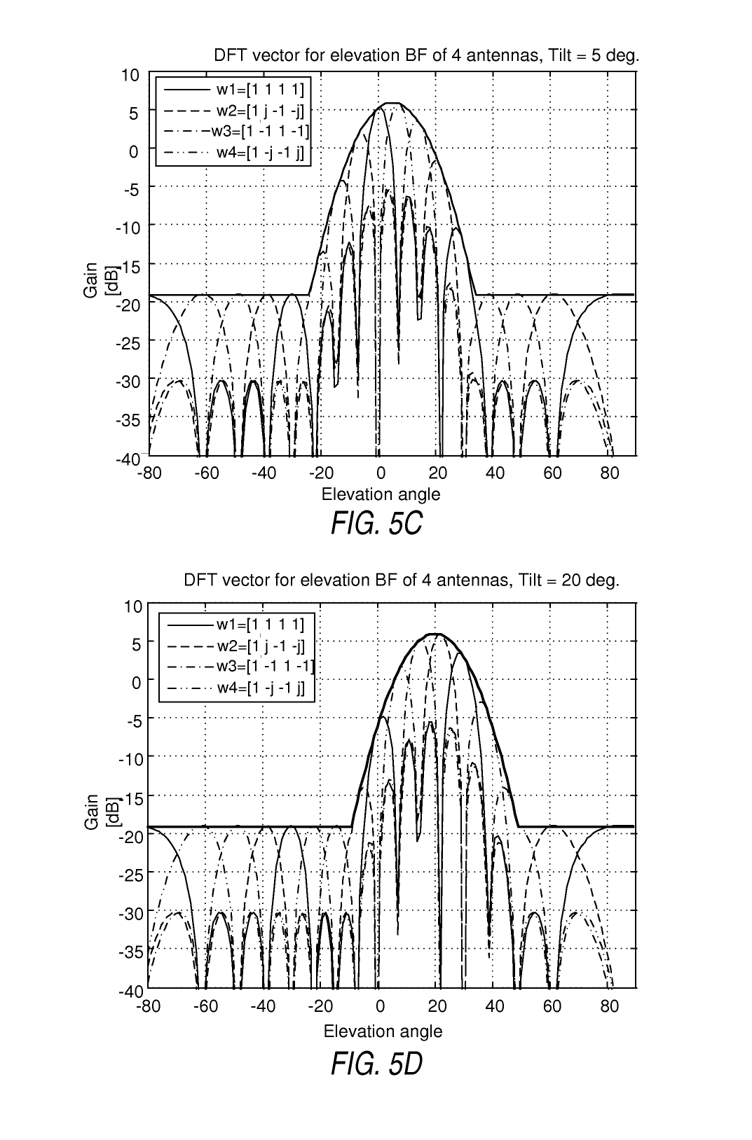

FIGS. 5A-5D are graphs illustrating the composite beam patterns using an example DFT codebook for elevation beamforming. The graph of FIGS. 5A and 5B represent an array having two antenna ports (E=2) with the number of DFT vectors (K=4), and dᵤ=2k. In FIG. 5A, the antenna pattern reflects a tilt of 5 degrees, while, in FIG. 5B, the antenna pattern reflects a tilt of 20 degrees. The graphs of FIGS. 5C and 5D represent an antenna having four antenna ports (E=4) with the number of DFT vectors (K=4), and dᵤ=2λ. In FIG. 5C, the antenna pattern reflects a tilt of 5 degrees, while, in FIG. 5D, the antenna pattern reflects a tilt of 20 degrees. As may be observed from each of the graphs in FIGS. 5A-5D, beamforming may control the phase between the ports, but the gain is less compared to the tilt control. For example, larger gain is observed for elevation angle of 20 degree at FIG. 5B and 5D than at FIG. 5A and 5C.

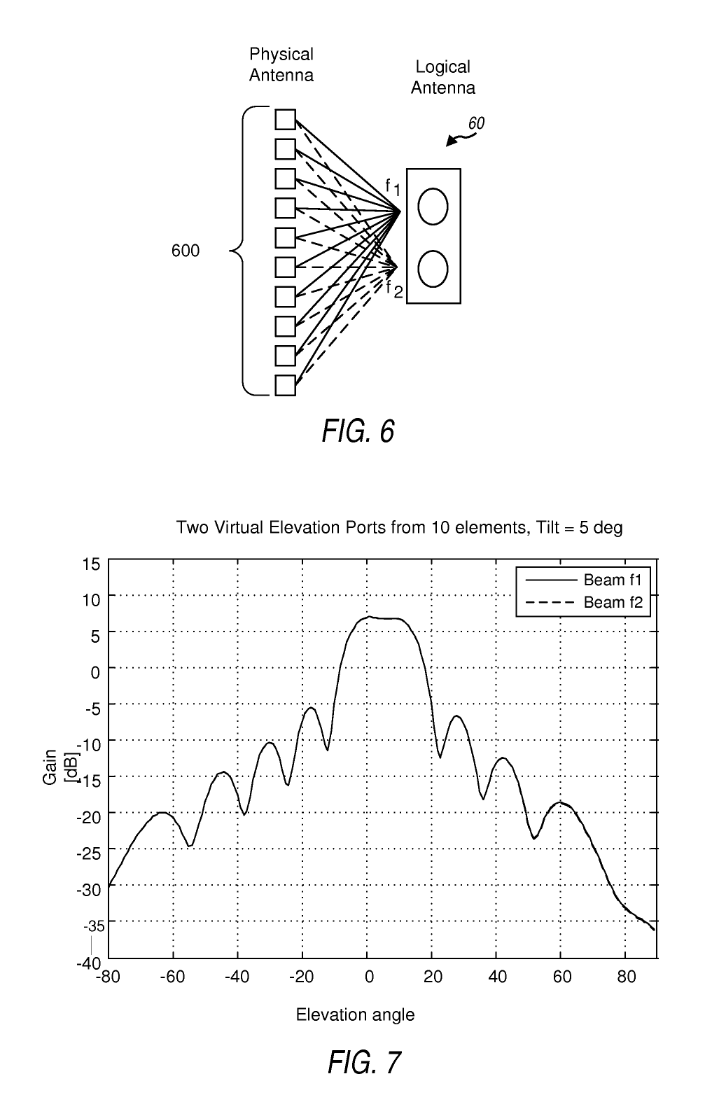

FIG. 6 is a block diagram illustrating a logical antenna 60. Logical antenna 60 includes virtual elevation ports, f1 and f2. Virtual elevation ports f1 and f2 may be mapped to physical antenna elements 600. As illustrated, there are ten physical elements in physical antenna elements 600 to which virtual elevation ports fl and f2 may be mapped. FIG. 7 is a graph representing the synthesized antenna pattern for logical antenna 60 having two virtual elevation ports, f1 and f2, and ten physical elements, with a tilt of 5 degrees.

Similar results as illustrated in FIGS. 4 and 5 may be observed for elevation beamforming with logical antenna ports. For example, assuming an antenna array which has M=10 physical elements with dᵤ=0.5λ spacing between elements mapped to two elevation antenna ports may use two orthogonal weights, e.g.,

f1=[−0.16, −0.09, 0.003, 0.11, 0.22, 0.32, 0.40, 0.455, 0.47, 0.46]

f2=[0.46, 0.47, 0.455, 0.40, 0.32, 0.22, 0.11, 0.003, −0.09, −0.16]*exp(jπ/4).

where f1 represents the weights for the first elevation antenna ports and f2 represents the weights for the second elevation antenna port. Assuming M=10, dᵤ=0.5λ, the number of antenna ports, E=2, and DFT vectors (K=4), the combined beamforming vector may be represented by the following equation:

vⱼ=[f₁⊙fₜᵢₗₜf₂⊙fₜᵢₗₜ]wⱼ (2)

where wⱼ is DFT vector.

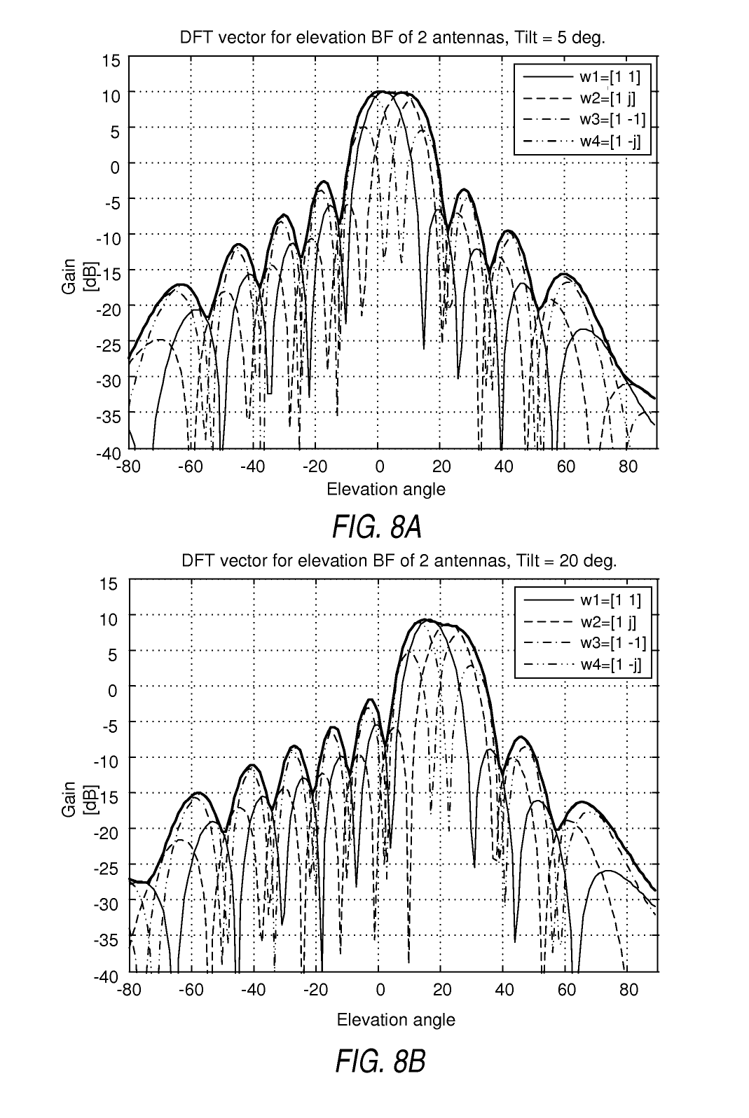

FIGS. 8A-8B are graphs illustrating the beam patterns using an example DFT codebook for elevation beamforming with logical antenna. The graph in FIG. 8A represents the antenna having a 5 degree tilt, while the graph in FIG. 8B represents the antenna having a 20 degree tilt. As observed in FIGS. 5A-5D, beamforming using a DFT codebook for multiple logical antennas also can control the phase between the two logical antenna ports to narrow the beam, but the gain is less compared to the tilt control.

In order to implement elevation beamforming that maps the elevation of the antenna beam to a specific UE direction, the DFT vector-based codebook should sample the elevation according to UE-specific direction. The envelope of a DFT vector-based beam is similar to the antenna vertical pattern, thus, elevation beamforming using DFT vectors generally have limited beamforming gain due to the relatively narrow beamwidth of the antenna vertical pattern. Various potential solutions for the limited beamforming gain have certain performance trade-offs or may not even affect the beamforming gain. For example, increasing the DFT vector size would generally only change the oversampling rate resulting in a very small increase of beamforming gain. Increasing the number of elevation antenna ports could have a larger effect on beamforming gain but at the expense of system overhead and complexity. Varying the downtilt would shift the antenna pattern in elevation resulting in different coverage or range of elevation angles. The largest beamforming gain can potentially be achieved if downtilt is adjusted on the UE basis, e.g., where each user is in the center of the antenna pattern. In addressing these issues with increase of elevation beamforming gain, joint consideration of downtilt and DFT vectors for elevation beamforming and codebook design should be explored, where downtilt may be used as an indicator of coarse spatial direction, while the DFT vector may be used as an indicator of fine beam within the downtilt indication.

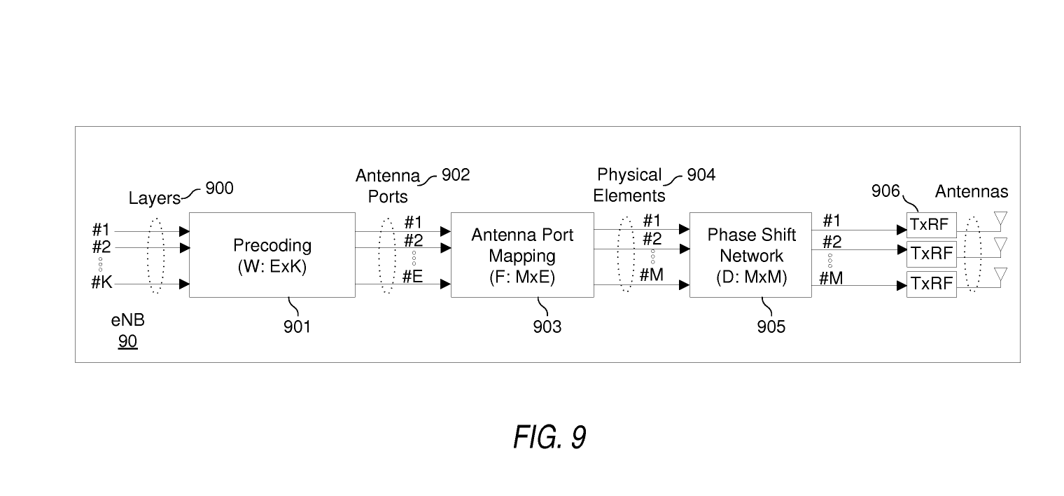

Various aspects of the present disclosure are directed to a flexible elevation beamforming. FIG. 9 is a block diagram illustrating an eNB 90 configured for flexible elevation beamforming according to one aspect of the present disclosure. Various data streams for transmission to a UE are processed into a number, K, of layers 900. A precoding matrix (W) is generated based on feedback received from the UE. The K layers 900 of processed data are precoded at precoder 901 using the precoding matrix, W, which precodes the K layers 900 onto a number, E, of antenna ports 902. For example, the precoder could utilize a DFT vector. The E antenna ports 902 carrying the precoded data of K layers 900 are mapped, at antenna port mapper 903, using an antenna mapping matrix (F) of the precoded symbol for each of the antenna ports 902 onto one or more of

M physical antenna elements 904. eNB 90 generates a phase shifting matrix (D) using UE- or layer-specific phase rotation values for each of physical antenna elements 904. At phase shift network 905, eNB 90 shifts the phase of the complex modulated symbols using the phase shifting matrix, D, for each of physical antenna elements 904. The phase-shifted transmissions are then processed through RF transmitter chains 906 and transmitted through antennas 907 to the target UE.

In the example depicted in FIG. 9, there are a total of M RF transmission chains/physical elements, but only E antenna ports (where, E<M) known by UE. The resulting mapping with antenna mapping matrix F is fixed and cell specific. The antenna mapping matrix F will determine the antenna vertical pattern and beam width, while the precoding matrix W and phase shift matrix D will be UE-specific, as determined from channel estimate matrices based on UE feedback.

It should be noted that the transmission chain for CSI-RS from eNB 90 for UE feedback measurements uses a similar process, except that precoding is not performed at precoder 901. Moreover, a UE-specific phase shift for downtilt may also be used for CSI-RS transmissions.

FIG. 10 is a functional block diagram illustrating example blocks executed to implement one aspect of the present disclosure. At block 1000, a base station applies a precoding matrix to layers of a data stream intended for transmission to a UE on E logical antenna ports. The precoding matrix is applied to each layer of the data stream to be transmitted. The base station generates the precoding matrix using PMI fed back from the UE in response to various reference signals transmitted from the base station.

At block 1001, the base station maps the now precoded symbols for the E logical antenna ports onto M physical antenna elements. The aspects of the present disclosure provide that M>>E. Thus, the precoded symbols for the E logical antenna ports are mapped to the larger M number of physical antenna elements. The base station uses a fixed and cell-specific antenna mapping matrix, F, that will determine the antenna vertical pattern.

At block 1002, the base station shifts the phase of these complex modulated symbols for each of the M physical antenna elements using a phase shift matrix, D, associated with the UE. This diagonal phase shift matrix, D, represents the additional phase shift corresponding to the UE-specific downtilt. Upon application of D, the channel is rotated in elevation related to the UE so that maximum elevation beamforming can be achieved. At block 1003, the base station transmits the beamformed symbols to the UE.

The base station may obtain D by exploiting channel reciprocity in TDD using the uplink SRS to determine the UE's downlink channel matrices. The base station would adjust the tilt using the determined D and transmit a reference signal from which the precoding matrix may be generated based on UE feedback to this reference signal.

Alternatively, the base station may obtain D using limited feedback from the UE to reference signals transmitted using a downtilt or shift matrix with close loop adjustment. The tilt adjustment based on the UE is obtained through the UE feedback to these reference signals. The UE also provides PMI feedback based on the first downtilt/shift matrix used to transmit the reference signal that the base station uses to generate the precoding matrix.

The base station may also obtain D using full feedback from the UE by transmitting a number of orthogonal reference signals using different shift matrices. The specific shift matrix to use is then determined based on the transmitted reference signal with one shift matrix that produces the best link quality as seen by the UE. Here, the base station adjusts the downtilt and transmits another reference signal to which the UE responds with PMI feedback. The base station uses this feedback to generate the precoding matrix.

At the UE side, the received signal can be represented by the following equation:

Yₙ=Hₙ·Dₙ·F·Wₙ·Xₙ (3)

where Xₙ is a K×1 vector denoting transmitter data streams of user n, Wₙ is an E×K precoding matrix, Dₙ is an M×M diagonal phase shift matrix, F is the cell specific antenna mapping matrix of M×E, and Hₙ is an N_{R}×M channel matrix (where N_{R} is the number of receiver antennas). The computation of Wₙ is based on the N_{R}×E composite channel H_{comp}=Hₙ·Dₙ·F, since the UE is only aware of E antenna ports instead of the M antenna available to the eNB. The construction of Wn can be the same as a traditional precoding matrix, such as using a DFT vector-based codebook. The diagonal shift matrix Dₙ denotes an additional phase shift corresponding to the UE-specific downtilt and is defined according to the following equation:

$${D}_{n} = [ \begin{matrix}1 & … & 0 \\ 0 & {e}^{j2π \frac{d sin {θ}_{n}}{λ}} & 0 \\ ⋮ & ⋱ & ⋮ \\ 0 & … & {e}^{j2π \frac{( M - 1 ) d sin {θ}_{n}}{λ}}\end{matrix} ] \qquad ( 4 )$$

The shift matrix Dₙ rotates the channel in elevation to be UE-centric, so that maximum elevation beamforming gain may be achieved.

FIG. 11 is a functional block diagram illustrating example blocks executed to implement one aspect of the present disclosure. At block 1100, a base station receives feedback from a UE related to one or more reference signals. The feedback received by the base station may then be used to adjust the downtilt and elevation codebook used for elevation beamforming from the base station to the UE.

At block 1101, the base station obtains a tilt adjustment based, at least in part, on the feedback from the UE. The tilt adjustment may be obtained by the base station using the uplink SRS, based on UE feedback on reference signals sent at a downtilt with close loop adjustment, based on UE feedback on a set of orthogonal reference signals transmitted at predetermined, different downtilts.

At block 1102, the base station generates an elevation precoding vector also based, at least in part, on the feedback. The feedback on which the elevation precoding vector is generated may be received in response to an additional reference signal after the base station adjusts the downtilt of the transmission from block 1101. It may also be received in response to the reference signal sent using the downtilt with close loop adjustment. Once the base station obtains the tilt adjustment and generates the elevation precoding vector and, at block 1103, performs elevation beamforming with its antenna array for the UE.

One of the challenges to implement the various aspects of the present disclosure is estimation of the Dₙ shift matrix. In a first optional estimation procedure, the channel reciprocity in TDD may be exploited. As such, the eNB obtains the users' downlink channel matrices of 1×M based on the uplink SRS reference signals. The eNB estimates the UE-specific downtilt angle and the shift matrix Dₙ using the estimated downlink channel matrices, e.g., from the largest eigenvector of the long-term averaged downlink channel covariance matrix of M×M . The eNB uses the estimated Dₙ to transmit CSI-RS for UE-specific feedback on the precoding matrix, Wₙ, for the elevation codebook.

In a second optional estimation procedure, an eNB may use limited feedback from the UE. In the limited feedback option, the eNB transmits CSI-RS with an initial cell downtilt, θₙ=θB_{n,i}, or a first shift matrix Dₙ=D_{n,i}. The UE estimates the channel matrices of these values in the CSI-RS and feeds back the elevation codebook, Wₙ, based on the estimates. The UE may also feedback an update command, δₙ, to request the eNB to increase or decrease the downtilt angle or shift matrix, Dₙ, by adjusting θₙ by a fixed amount, such as either by +Δθ or by −Δθ, where Δθ is fixed step, e.g., θ_{n,i+1}=θ_{n,i}+Δθ or θ_{n,i+1}=θ_{n,i}−Δθ. The eNB will use the updated shift matrix, Dₙ, for the next CSI-RS transmission opportunity.

It should be noted that in additional aspects of the present disclosure, the UE may select an adjustable amount in which to adjust θₙ. The present disclosure is not limited to any certain methods for implementing the adjustment feedback.

For example, assuming a composite channel received by the UE is H(k) and the channel codebook set is C, which is divided into two parts: C₊ and C₋. All entries in C₊ will lead to positive tilt adjustment, while all entries in C₋ will lead to negative tilt adjustment. If the UE is in the center of the antenna pattern, then entries in each set C₊ and C₋ will indicate equal power in each set.

When the UE receives the estimated channel matrices, it computes the eigenvector of the long-term averaged channel covariance using the following equation:

μ=eig{E(H^{H}(k)H(k))} (5)

The UE picks a codebook entry from the set of C₊ and C₋ and computes the inner product μ^{H}Cⱼ. A positive update command of Dₙ will be generated by the UE when

Σj∈C₊|μ^{H}Cⱼ|²>Σk∈C⁻|μ^{H}Cₖ|² (6)

Otherwise, the UE will generate a negative update command or provide no adjustment at all.

In a third optional estimation procedure, an eNB may use full feedback from the UE. In the full feedback option, the eNB transmits N orthogonal CSI-RS (e.g., either FDM or TDM) using N different shift matrices, D_{n(N)}-D_{n(N+2)}. Each UE measures and reports the received link quality corresponding to each shift matrix D_{n(N)}-D_{n(N+2)}. Each UE will be associated with the shift matrix D_{n(N)}-D_{n(N+2)} that yields the best link quality.

The eNB then uses the best-associated UE-specific shift matrix Dₙ to transmit CSI-RS for elevation codebook feedback. The UE will periodically monitor and update the best shift matrix D_{n(N)}-D_{n(N+2)} to the eNB, but on a low frequency in order to reduce the potential for hopping between different shift matrices too quickly, which may affect overall performance and efficiency.

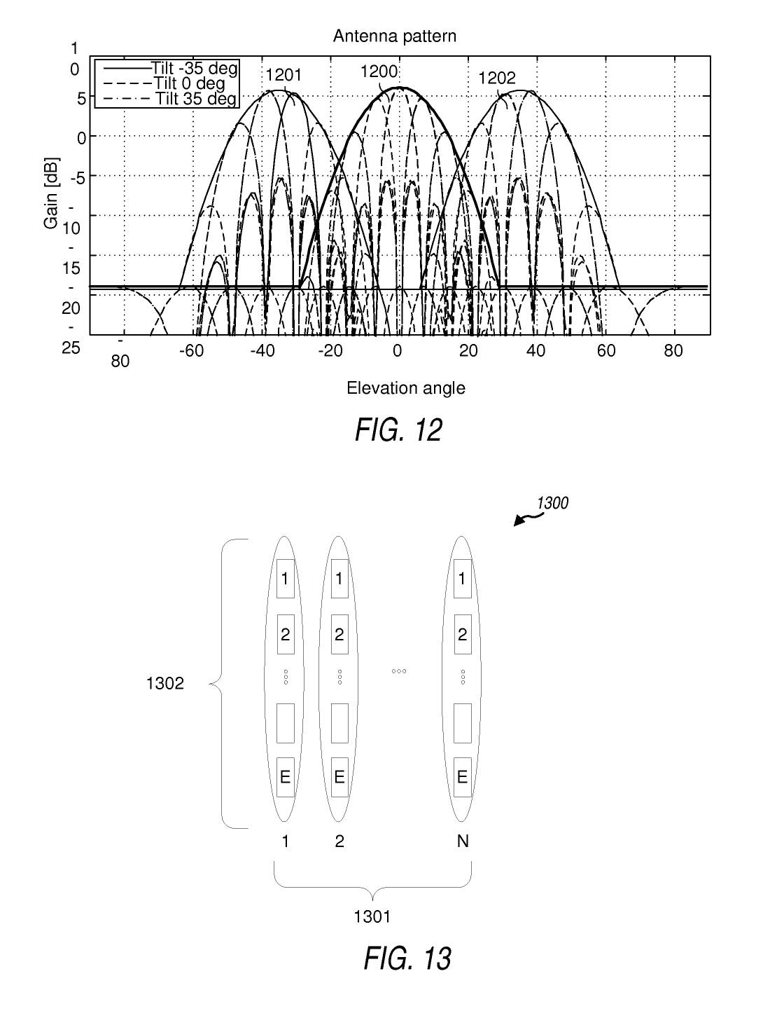

FIG. 12 is a graph illustrating antenna patterns 1200-1202 attributable to different orthogonal reference signals in a shift matrix estimation procedure configured according to one aspect of the present disclosure. With reference to the third option for estimating the shift matrix, Dₙ, above, the number of orthogonal reference signals are sent using different shift matrices. For example, antenna pattern 1200 was sent with a shift matrix that resulted in the highest gain occurring at a downtilt of 0 degrees, while the antenna pattern 1201 was sent with a shift matrix resulting in the highest gain occurring at −35 degrees and antenna pattern 1202 was sent with a shift matrix resulting in the highest gain occurring at +35 degrees. When measuring the quality of the reference signals transmitted at each of the three shift matrices, the UE will be associated with the specific shift matrix that measures out at the best link quality with respect to the UE.

These implementations of flexible elevation beamforming may be applied, in various aspects of the present disclosure, to two-dimensional (2D) Uniform Planar Array antenna deployments. FIG. 13 is a block diagram illustrating a 2D UPA antenna array 1300 configured according to one aspect of the present disclosure. Assuming a number of columns, N (subarray 1, 2 . . . N) subarrays 1301, and E ports 1302 per subarray 1301 mapped to M physical elements, the channel may be defined according to the following equation:

H(k)=[H₁(k)|H₂(k)|H_{N}(k)] (7)

where Hᵢ(k) are N_{R}×M channel matrices. The phase shift matrix, Dₙ, and antenna mapping matrix, F, would be applied for each subarray 1301 separately, where the received signal would be denoted according to the following equation:

Y(k)=H(k)·(I_{N}\textcircled{x}Dₙ)·(I_{N}\textcircled{x}F)·Wₙ·XₙXₙ (8)

where the precoding matrix, Wₙ, is an NE×1 channel codebook based on the UE-specific feedback.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 10 and 11 may comprise processors, electronics devices, hardware devices, electronics components, logical circuits, memories, software codes, firmware codes, etc., or any combination thereof

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving, at a base station, feedback from a user equipment (UE), wherein the feedback is related to one or more reference signals;
obtaining, at the base station, a tilt adjustment based, at least in part, on the feedback;
generating an elevation precoding vector based, at least in part, on the feedback; and
performing elevation beamforming with an antenna array of the base station for the UE using the tilt adjustment and elevation precoding vector.

2. The method of claim 1, wherein the receiving the feedback includes:
receiving, at the base station, uplink reference signals from the UE; and
obtaining downlink channel matrices of the UE based on the uplink reference signals.

3. The method of claim 2, wherein the obtaining the tilt adjustment includes estimating a downtilt angle associated with the UE using the downlink channel matrices.

4. The method of claim 3, further including:
transmitting, from the base station, a reference signal of the one or more reference signals using the tilt adjustment, wherein the receiving the feedback further includes receiving precoding information from the UE related to the reference signal.

5. The method of claim 1, wherein the one or more reference signals include a reference signal transmitted at an initial tilt adjustment, wherein the receiving the feedback includes:
receiving precoding information from the UE related to the reference signal; and
receiving a tilt update from the UE based on the reference signal.

6. The method of claim 5, wherein the tilt update includes one of:
a fixed tilt adjustment indicator; and
a selectable tilt adjustment selected by the UE.

7. The method of claim 5, further comprising:
adjusting the initial tilt adjustment using the tilt update.

8. The method of claim 1, wherein the one or more reference signals include a predetermined plurality of orthogonal reference signals, wherein each of the predetermined plurality of orthogonal reference signals is transmitted using an associated tilt adjustment, wherein the receiving the feedback includes:
receiving precoding information and measurement information from the UE for each of the predetermined plurality of orthogonal reference signals.

9. The method of claim 8, wherein the obtaining the tilt adjustment includes:
identifying the associated tilt adjustment related to one of the predetermined plurality of orthogonal reference signals having a best link quality based on the measurement information received from the UE.

10. The method of claim 9, further including:
transmitting, from the base station, a reference signal of the one or more reference signals using the tilt adjustment.

11. The method of claim 1, wherein the feedback received from the UE is based on a first number, E, of antenna ports visible to the UE while the elevation beamforming performed by the base station uses a second number, M, of physical antenna elements, wherein M>>E.

12. The method of claim 1, wherein the antenna array is a two-dimensional array of a first number, N, of subarrays, in which each of the N subarrays includes a second number, E, of antenna ports mapped to a third number, M, of physical elements, wherein the performing the elevation beamforming includes applying the tilt adjustment and the elevation precoding vector to each of the N subarrays separately.

13. An apparatus configured for wireless communication, comprising:
means for receiving, at a base station, feedback from a user equipment (UE), wherein the feedback is related to one or more reference signals;
means for obtaining, at the base station, a tilt adjustment based, at least in part, on the feedback;
means for generating an elevation precoding vector based, at least in part, on the feedback; and
means for performing elevation beamforming with an antenna array of the base station for the UE using the tilt adjustment and elevation precoding vector.

14. The apparatus of claim 13, wherein the means for receiving the feedback include:
means for receiving, at the base station, uplink reference signals from the UE; and
means for obtaining downlink channel matrices of the UE based on the uplink reference signals.

15. The apparatus of claim 14, wherein the means for obtaining the tilt adjustment include means for estimating a downtilt angle associated with the UE using the downlink channel matrices.

16. The apparatus of claim 15, further including:
means for transmitting, from the base station, a reference signal of the one or more reference signals using the tilt adjustment, wherein the means for receiving the feedback further include means for receiving precoding information from the UE related to the reference signal.

17. The apparatus of claim 13, wherein the one or more reference signals include a reference signal transmitted at an initial tilt adjustment, wherein the means for receiving the feedback include:
means for receiving precoding information from the UE related to the reference signal; and
means for receiving a tilt update from the UE based on the reference signal.

18. The apparatus of claim 17, wherein the tilt update includes one of:
a fixed tilt adjustment indicator; and
a selectable tilt adjustment selected by the UE.

19. The apparatus of claim 17, further comprising:
means for adjusting the initial tilt adjustment using the tilt update.

20. The apparatus of claim 13, wherein the one or more reference signals include a predetermined plurality of orthogonal reference signals, wherein each of the predetermined plurality of orthogonal reference signals is transmitted using an associated tilt adjustment, wherein the means for receiving the feedback include:
means for receiving precoding information and measurement information from the UE for each of the predetermined plurality of orthogonal reference signals.

21. The apparatus of claim 20, wherein the means for obtaining the tilt adjustment include:
means for identifying the associated tilt adjustment related to one of the predetermined plurality of orthogonal reference signals having a best link quality based on the measurement information received from the UE.

22. The apparatus of claim 21, further including:
means for transmitting, from the base station, a reference signal of the one or more reference signals using the tilt adjustment.

23. The apparatus of claim 13, wherein the feedback received from the UE is based on a first number, E, of antenna ports visible to the UE while the elevation beamforming performed by the base station uses a second number, M, of physical antenna elements, wherein M>>E.

24. The apparatus of claim 13, wherein the antenna array is a two-dimensional array of a first number, N, of subarrays, in which each of the N subarrays includes a second number, E, of antenna ports mapped to a third number, M, of physical elements,
wherein the means for performing the elevation beamforming include means for applying the tilt adjustment and the elevation precoding vector to each of the N subarrays separately.

25. A computer program product for wireless communications in a wireless network, comprising:
a non-transitory computer-readable medium having program code recorded thereon, the program code including:
program code for causing a computer to receive, at a base station, feedback from a user equipment (UE), wherein the feedback is related to one or more reference signals;
program code for causing the computer to obtain, at the base station, a tilt adjustment based, at least in part, on the feedback;
program code for causing the computer to generate an elevation precoding vector based, at least in part, on the feedback; and
program code for causing the computer to perform elevation beamforming with an antenna array of the base station for the UE using the tilt adjustment and elevation precoding vector.

26. The computer program product of claim 25, wherein the program code for causing the computer to receive the feedback includes program code for causing the computer to:
receive, at the base station, uplink reference signals from the UE; and
obtain downlink channel matrices of the UE based on the uplink reference signals.

27. The computer program product of claim 26, wherein the program code for causing the computer to obtain the tilt adjustment includes program code for causing the computer to estimate a downtilt angle associated with the UE using the downlink channel matrices.

28. The computer program product of claim 27, further including:
program code for causing the computer to transmit, from the base station, a reference signal of the one or more reference signals using the tilt adjustment, wherein the program code for causing the computer to receive the feedback further includes program code for causing the computer to receive precoding information from the UE related to the reference signal.

29. The computer program product of claim 25, wherein the one or more reference signals include a reference signal transmitted at an initial tilt adjustment, wherein the program code for causing the computer to receive the feedback includes program code for causing the computer to:
receive precoding information from the UE related to the reference signal; and
receive a tilt update from the UE based on the reference signal.

30. The computer program product of claim 25, wherein the one or more reference signals include a predetermined plurality of orthogonal reference signals, wherein each of the predetermined plurality of orthogonal reference signals is transmitted using an associated tilt adjustment, wherein the program code for causing the computer to receive the feedback includes program code for causing the computer to receive precoding information and measurement information from the UE for each of the predetermined plurality of orthogonal reference signals.

31. The computer program product of claim 30, wherein the program code for causing the computer to obtain the tilt adjustment includes program code for causing the computer to identify the associated tilt adjustment related to one of the predetermined plurality of orthogonal reference signals having a best link quality based on the measurement information received from the UE.

32. The computer program product of claim 25, wherein the antenna array is a two-dimensional array of a first number, N, of subarrays, in which each of the N subarrays includes a second number, E, of antenna ports mapped to a third number, M, of physical elements,
wherein the program code for causing the computer to perform the elevation beamforming includes program code for causing the computer to apply the tilt adjustment and the elevation precoding vector to each of the N subarrays separately.

33. An apparatus configured for wireless communication, the apparatus comprising:
at least one processor; and
a memory coupled to the at least one processor,
wherein the at least one processor is configured:
to receive, at a base station, feedback from a user equipment (UE), wherein the feedback is related to one or more reference signals;
to obtain, at the base station, a tilt adjustment based, at least in part, on the feedback;
to generate an elevation precoding vector based, at least in part, on the feedback; and
to perform elevation beamforming with an antenna array of the base station for the UE using the tilt adjustment and elevation precoding vector.

34. The apparatus of claim 33, wherein the configuration of the at least one processor to receive the feedback includes configuration to:
receive, at the base station, uplink reference signals from the UE; and
obtain downlink channel matrices of the UE based on the uplink reference signals.

35. The apparatus of claim 34, wherein the configuration of the at least one processor to obtain the tilt adjustment includes configuration to estimate a downtilt angle associated with the UE using the downlink channel matrices.

36. The apparatus of claim 35, further including:
configuration of the at least one processor to transmit, from the base station, a reference signal of the one or more reference signals using the tilt adjustment, wherein the configuration of the at least one processor to receive the feedback further includes configuration to receive precoding information from the UE related to the reference signal.

37. The apparatus of claim 33, wherein the one or more reference signals include a reference signal transmitted at an initial tilt adjustment, wherein the configuration of the at least one processor to receive the feedback includes configuration to:
receive precoding information from the UE related to the reference signal; and
receive a tilt update from the UE based on the reference signal.

38. The apparatus of claim 33, wherein the one or more reference signals include a predetermined plurality of orthogonal reference signals, wherein each of the predetermined plurality of orthogonal reference signals is transmitted using an associated tilt adjustment, wherein the configuration of the at least one processor to receive the feedback includes configuration to receive precoding information and measurement information from the UE for each of the predetermined plurality of orthogonal reference signals.

39. The apparatus of claim 38, wherein the configuration of the at least one processor to obtain the tilt adjustment includes configuration to identify the associated tilt adjustment related to one of the predetermined plurality of orthogonal reference signals having a best link quality based on the measurement information received from the UE.

40. The apparatus of claim 33, wherein the antenna array is a two-dimensional array of a first number, N, of subarrays, in which each of the N subarrays includes a second number, E, of antenna ports mapped to a third number, M, of physical elements,
wherein the configuration of the at least one processor to perform the elevation beamforming includes configuration to apply the tilt adjustment and the elevation precoding vector to each of the N subarrays separately.
